(19) United States
(12) Patent Application Publication
(10) Pub. No.: US 2011/0292213 A1
(43) Pub. Date: Dec. 1, 2011

(54) DOOR MOUNTABLE CAMERA SURVEILLANCE DEVICE AND METHOD

(76) Inventor: James H. Lacey, Austin, TX (US)

(21) Appl. No.: 13/115,164

(22) Filed: May 25, 2011

Related U.S. Application Data
(60) Provisional application No. 61/348,664, filed on May 26, 2010.

(51) Int. Cl. H04N 7/18

(52) U.S. Cl. 348/153; 348/152; 348/154; 348/E07.085

(57) ABSTRACT

One embodiment pertains to a surveillance device having at least two video cameras contained within a housing of the surveillance device. The device is configured to couple to at least one side of a door. One of the two cameras is positioned on one side of the surveillance device in order to record video images on one side of the door while the another camera is positioned on an opposite side of the surveillance device to record video images on the other side of the door. As the door opens and closes, the two video cameras are able to record a wider, sweeping angle of the interior and exterior areas of the door. The surveillance device may be mounted onto the door at a height near the average height of a human in order to maximize image capture of people's faces as they enter or exit through the door.

### CLAIM OF PRIORITY

The present application for patent claims priority to U.S. Provisional Patent Application No. 61/348,664 entitled “Door Mountable Dual Camera Security Apparatus” filed May 26, 2010, the entire disclosure of which is hereby expressly incorporated by reference herein.

### FIELD

Generally, the present application pertains to a security surveillance device. More particularly, various embodiments pertain to the surveillance of an interior and/or an exterior area of doorways/entryways.

### BACKGROUND

In the field of security surveillance, video camera surveillance of doorways/entryways is commonplace. Conventional doorway surveillance systems typically comprise individual cameras that are mounted to a fixed support, such as a wall, to monitor and video record a specific area, for example, the exterior of a doorway. If the other side of the doorway is to be recorded, a separate camera is typically mounted on that side of the doorway as well. In most cases the video cameras are mounted at a height above the frame of the doorway at an angle looking down. In some cases the video cameras may also be mounted at some considerable distance from the doorway.

Such conventional doorway surveillance systems have significant limitations. Since the video cameras are permanently mounted to a fixed support, such as a wall or ceiling, they typically will each only record a narrow viewing area, for example, the exterior or interior entrance of the doorway. This requires separate cameras to be mounted at some expense for each narrow view of interest. Moreover, if the video cameras are mounted high and angled down, then image acquisition of the face of a person walking in and out of the doorway may be compromised.

It is an object of the surveillance devices disclosed herein to provide for video recording of the interior and/or exterior of a doorway. It is a further object of the surveillance devices disclosed herein to allow two video cameras to record a wider, panoramic viewing angle than cameras affixed to a wall or doorframe conventionally used for doorway surveillance. It is an additional object of the surveillance devices disclosed herein to accurately and clearly capture the facial images of people entering and exiting through a doorway. It is an additional object of the surveillance devices disclosed herein to be relatively compact, easy to install, and attach to various types of doors without major modifications.

### SUMMARY

A surveillance device is disclosed, comprising: a first video camera; and a housing defining a cavity that contains, at least partially, the first video camera, the housing having a first camera opening and adapted to couple to a first side of a door, wherein the first video camera captures images through the first camera opening whether the door is in a stationary position or in motion. In one embodiment, the housing of the surveillance device further comprises a first end and a second end, the second end located opposite to the first end, the first end having a first end bracket adapted to couple the first end of the housing to a first perimeter portion of the door, and the second end having a second end bracket adapted to couple the second end of the housing to a second perimeter portion of the door. In another embodiment, the housing of the surveillance device comprises a first end and a second end, the second end located opposite to the first end, and wherein at least one of the first end and the second end is a telescoping end.

In another embodiment, the surveillance device further comprises a processor coupled to the first video camera and adapted to process video data including the images acquired by the first video camera; and a communications interface coupled to the processor and adapted to transmit the video data including the images to an external storage device. In yet another embodiment, the surveillance device further comprises a processor coupled to the first video camera and adapted to process video data including the images acquired by the first video camera; and a video data storage apparatus coupled to the processor and adapted to store the video data including the images on at least one memory circuit housed within the storage apparatus, wherein the video data storage apparatus is removably coupled to the surveillance device.

In yet another embodiment, the housing of the surveillance device is coupled to the first side of the door such that the first video camera is positioned at a height between four (4) feet six (6) inches and six (6) feet six (6) inches to capture facial images of humans approaching the first side of the door. In another embodiment, the surveillance device further comprises a second video camera contained, at least partially, within the cavity of the housing and adapted to capture additional images through a second camera opening in the housing, the second video camera adapted to capture the additional images whether the door is in the stationary position or in motion. The first video camera may be positioned adjacent to the second video camera in order to reduce the thickness of the housing. Moreover, the images captured by the first video camera may be located in a first area on the first side of the door, and the additional images captured by the second video camera may be located in a second area on a second side of the door, the second side of the door being an opposite side of the first side of the door.

In yet another embodiment, the door to which the surveillance device attaches to may be substantially transparent. In another embodiment, the first video camera is adapted to capture the images within a viewing angle α₁ located in a first area on the first side of the door when the door is in a stationary position, and the first video camera is adapted to capture the images located within a viewing angle β₁ when the door is in motion, wherein β₁ is greater than α₁. In yet another embodiment, the viewing angle β₁ includes images located in the first area on the first side of the door and images located in a second area on a second side of the door, the second side of the door being an opposite side of the first side of the door. In yet another embodiment, the surveillance device may further comprise a second video camera contained, at least partially, within the cavity of the housing and adapted to capture images while the door is in the stationary position and in motion, the second video camera adapted to capture images located in the second area on the second side of the door within a viewing angle α₂ when the door is in a stationary position, the second video camera adapted to capture images located within a viewing angle β₂ when the door is in motion, the angle β₂ being greater than the angle α₂, wherein the viewing angle β₂ includes images located in the first area on the first side of the door and images located in the second area on the second side of the door.

In another embodiment, a surveillance device is disclosed, comprising: a first video camera adapted to capture a first video data of images located in a first area associated with an interior side of a door; a second video camera adapted to capture a second video data of images located in a second area associated with an exterior side of the door; a first housing defining a first cavity that contains, at least partially, the first video camera, the first housing adapted to couple to the interior side of the door; a second housing defining a second cavity that contains, at least partially, the second video camera, the second housing adapted to couple to the exterior side of the door; and a communications line communicatively coupling the first video camera to the second video camera. In one embodiment, the first video camera and the second video camera are respectively positioned on the interior side and exterior side of the door at a height above ground to capture facial images of humans approaching the door. In yet another embodiment, the door is substantially opaque.

In another embodiment, a surveillance device is disclosed, comprising: a first video camera adapted to record a first video data of a first doorway region associated with a first side of a substantially transparent door; a second video camera adapted to record a second video data of a second doorway region associated with a second side of the door, the second side of the door opposite the first side of the door; and a casing defining a cavity that contains, at least partially, the first video camera and the second video camera, the casing having a first camera opening through which the first video camera records the first video data and a second camera opening through which the second video camera records the second video data, the casing adapted to couple to the first side of the door. In another embodiment, the first camera opening faces away from the first side of the door, and the second camera opening faces toward the first side of the door. In another embodiment, the casing comprises: a first end and a second end, the second end located opposite to the first end, the first end having a first end bracket adapted to couple the first end of the casing to a first perimeter portion of the door, and the second end having a second end bracket adapted to couple the second end of the casing to a second perimeter portion of the door. In yet another embodiment, the first video camera is adapted to record the first video data within a viewing angle α₁ when the door is in a stationary position, and further adapted to record the first video data within a viewing angle β₁ when the door is in motion, wherein β₁ is greater than α₁.

### BRIEF DESCRIPTION OF THE DRAWINGS

FIG. 1 illustrates one embodiment of a surveillance device attached to a door.

FIGS. 2 and 3 illustrate front and rear perspective views of a surveillance device.

FIG. 4 illustrates a view of a first end of a surveillance device.

FIG. 5 illustrates a view of a front surface of a surveillance device.

FIG. 6 illustrates a cross-sectional view of the top side of a portion of a surveillance device that houses a first camera a second camera.

FIG. 7 illustrates a cross-sectional view of an end of the surveillance device that shows the first camera being held in place by the first camera fastener.

FIGS. 8 and 9 illustrate a door featuring a surveillance device that captures images of an interior area and an exterior area of a doorway.

FIG. 10 illustrates a top-side view of a surveillance device.

FIG. 11 illustrates a surveillance device attached to a substantially transparent door.

FIG. 12 illustrates a cross-sectional view of a door and a surveillance device attached thereto.

FIG. 13 illustrates a top side view of a surveillance device in an initial closed position and a second open position.

FIG. 14 illustrates another embodiment of a surveillance device that may be mounted on an opaque door to provide video surveillance of both the interior and exterior areas of a door.

FIG. 15 illustrates one embodiment of a surveillance device having a housing with a telescoping end.

FIG. 16 illustrates a functional block diagram of a surveillance system comprising a surveillance device and an external storage device according to one embodiment.

FIG. 17 illustrates a functional block diagram of a surveillance device according to another embodiment.

FIG. 18 illustrates a flowchart of an exemplary method for capturing surveillance images of objects on a first side and/or second side of a doorway.

### DETAILED DESCRIPTION

In the following description numerous specific details are set forth in order to provide a thorough understanding of the invention. However, one skilled in the art would recognize that the invention might be practiced without these specific details. In other instances, well known methods, procedures, and/or components have not been described in detail so as not to unnecessarily obscure aspects of the invention.

Overview

In one embodiment, a surveillance device having a camera is provided where the surveillance device is configured to couple to one side of a door. The camera is positioned to record images and activity occurring at least on one side of the door, including for example, facial images of people approaching the side of the door onto which the device is coupled. Moreover, as the door opens and closes, the video camera is able to record a wider, sweeping angle of the interior and possibly exterior areas of the door in order to maximize video surveillance.

In another embodiment, a surveillance device having at least two video cameras is provided that is configured to couple to a door. One of the two cameras is positioned on one side of the surveillance device in order to record video images on one side of the door while the other camera is positioned on an opposite side of the surveillance device to record video images on the other side of the door. As the door opens and closes, the two video cameras are able to record a wider, sweeping angle of the interior and exterior areas of the door in order to maximize video surveillance. The surveillance device may be mounted onto the door at a height near the average height of a human in order to maximize image capture of people's faces as they enter or exit through the door. In one embodiment, the surveillance device comprises one housing that include both cameras facing opposite directions and is configured to attach to a substantially transparent door. In another embodiment, the surveillance device comprises two cameras that affix to opposite sides of an opaque door so as to simultaneously record activity taking place on both sides of the door.

Components of Surveillance Device

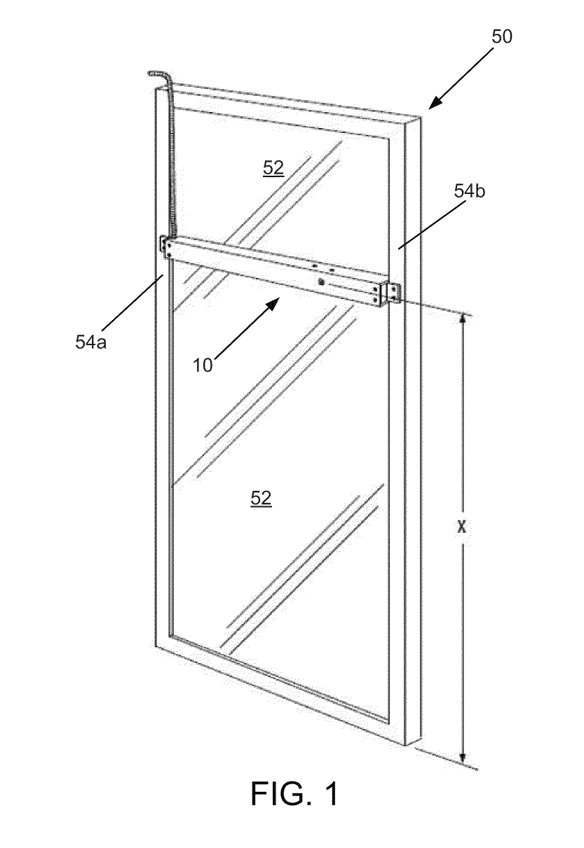

FIG. 1 illustrates one embodiment of a surveillance device 10 attached to a door 50. In one embodiment the door 50 is substantially comprised of a transparent material 52, such as glass, plexi-glass, bullet resistant glass, or other durable transparent material allowing visibility from one side of the door to the other. The surveillance device 10 is preferably situated at a height “X” that is about face level with the height of an average adult person, and is affixed to the perimeter portions 54a, 54b of the door 50. For example, in one embodiment, the height “X” may be any height between four (4) feet six (6) inches and six (6) feet six (6) inches. In one embodiment, the door 50 may be a standard hinged door that pivots away from the doorway in only one direction. That is, the standard hinged door may open in only one direction. In other embodiments, the door 50 may be a “swing door” whose hinges allow it to pivot away from the doorway in two directions. Thus, a swing door may be pushed and pulled open by a person standing on either side of the door.

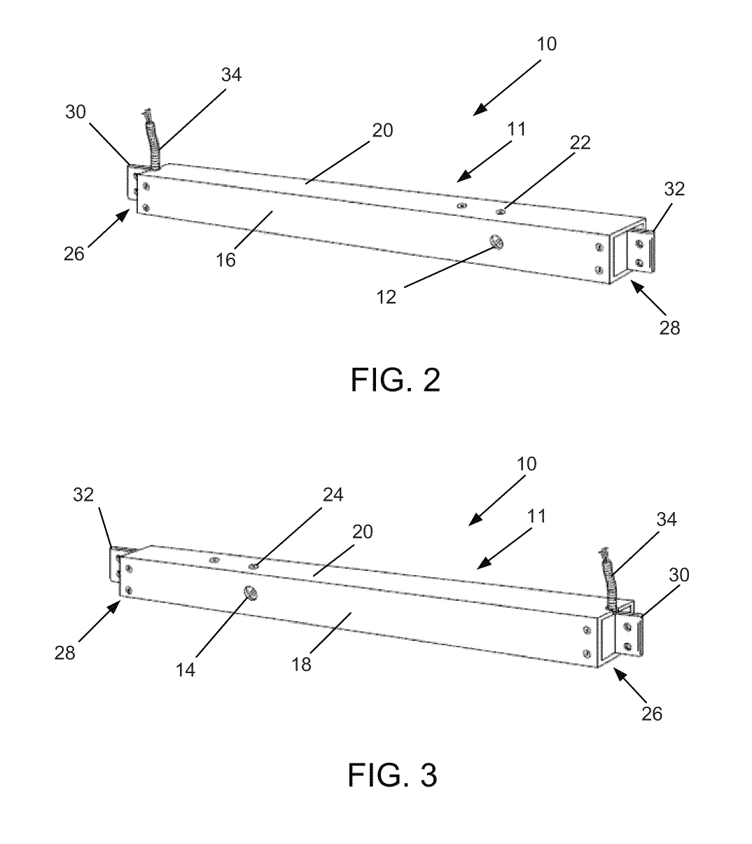

FIGS. 2 and 3 illustrate front and rear perspective views of the surveillance device 10. In one embodiment, the surveillance device 10 comprises a housing (e.g., a casing) 11, a first camera 12 (e.g., first video camera), a second camera 14 (e.g., second video camera), a front surface 16, a rear surface 18, a top surface 20, a first camera fastener 22, a second camera fastener 24, a first end 26, a second end 28, a first end bracket 30, a second end bracket 32, and a cable 34.

The housing 11 may be composed of plastic, metal, or any other rigid material. The housing 11 serves to define a cavity within which various components of the surveillance device 10 may be, at least partially, housed. For example, the first and second cameras 12, 14 may be contained at least partially within the housing 11 of the surveillance device 10. In one embodiment, the housing 11 may be comprised a of bullet resistant material such as Kevlar®.

The first end bracket 30 and the second end bracket 32 allow the surveillance device 10 to be permanently, semi-permanently, or temporarily affixed to the perimeter portions 54a, 54b of the door 50, as shown in FIG. 1. The first end 26 of the surveillance device 10 may be affixed onto or near a first perimeter portion 54a of the door 50 via the first end bracket 30. The first perimeter portion 54a of the door 50 may be the edge of the door 50 that attaches to the doorway using hinges. The second end 28 of the surveillance device 10 may be affixed onto or near the second perimeter portion 54b of the door via the second end bracket 32. The second perimeter portion 54b of the door 50 may be the edge of the door 50 that swings open. Thus, the surveillance device 10 and the housing 11 may be mounted onto the first side of the door in a horizontal orientation across the door.

In one embodiment, the first camera 12 and the second camera 14 may be video cameras, for example, digital video cameras that capture/record more than sixteen digital images per second. In another embodiment, the first camera 12 and the second camera 14 may be digital cameras. The digital cameras may capture digital images intermittently at a fixed time interval and/or based on a triggering event. For example, in one embodiment, the first and second cameras 12, 14 may be triggered to capture at least one image if a motion sensor located in or around the surveillance device 10 detects motion within an active region of the motion sensor.

The first camera 12 may be found on the front surface 16 of the surveillance device 10, and may be held in place by the first camera fastener 22 on the top surface 20 of the surveillance device 10. The second camera 14 may be found on the rear surface 18 of the surveillance device 10, and may be held in place by the second camera fastener 24 on the top surface 20 of the surveillance device 10. In other embodiments, the first and second camera fasteners 22, 24 may be located on the bottom surface of the surveillance device 10. In yet other embodiments, one or more camera fasteners may be used to secure the cameras 12, 14 from any one of surfaces of the surveillance device 10.

The cable 34 may be coupled to the surveillance device 10 near the first end 26 of the surveillance device 10. For example, the cable 34 may be secured within the cavity of the housing 11 and be protected from intentional or unintentional damage as it runs from the cameras 12, 14 to a first edge of the door 50. The cable 34 may be comprised of a power line that provides power to the surveillance device 10, including power to the first camera 12 and/or the second camera 14. In one embodiment, the cable 34 also includes a communications line that provides a line of communication (e.g., receive and transmit signals) between the cameras 12, 14 and an external storage device that serves to save and store the images captured by the cameras 12, 14. The external storage device may be a unit such as a hard drive or memory that is located separate and apart from the surveillance device 10 and is configured to store large amounts of video data. In other embodiments the cameras 12, 14 transmit the video images they capture wirelessly to the external storage device. In yet other embodiments, the cable 34 is not present. Instead, the cameras 12, 14 may be battery operated and/or solar panel operated, and transmit the video images they capture wirelessly to the external storage device.

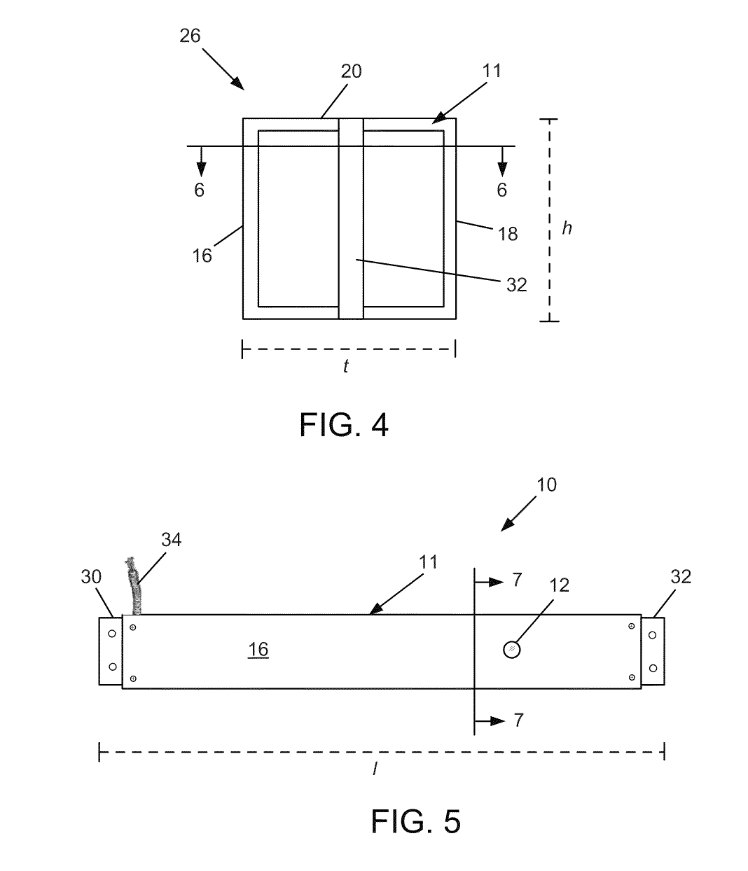

FIG. 4 illustrates a side view of the first end 26 of the surveillance device 10. The housing 11 of the surveillance device 10 may have a thickness t and a height h, and may have, at least in part, a rectangular cross section. In other embodiments, the housing 11 may be cylindrical in shape, or have a cross section, in part, of any number of sides equal to or greater than three.

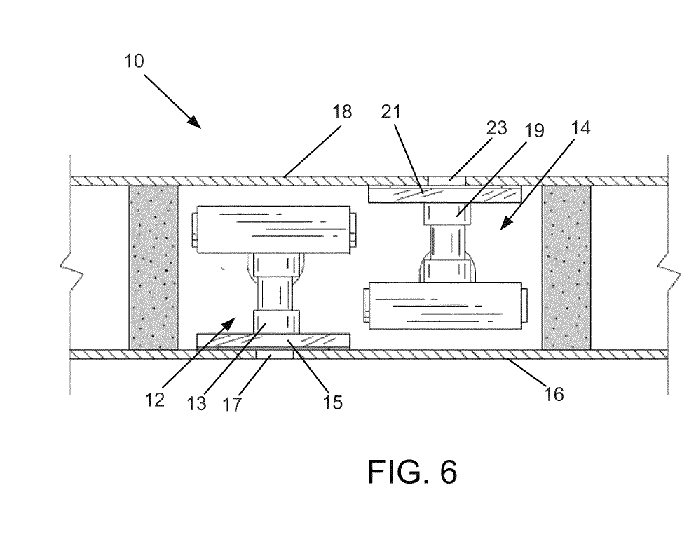

FIG. 5 illustrates a view of the front surface 16 of the surveillance device 10. The housing 11 of the surveillance device 10 may have length 1.

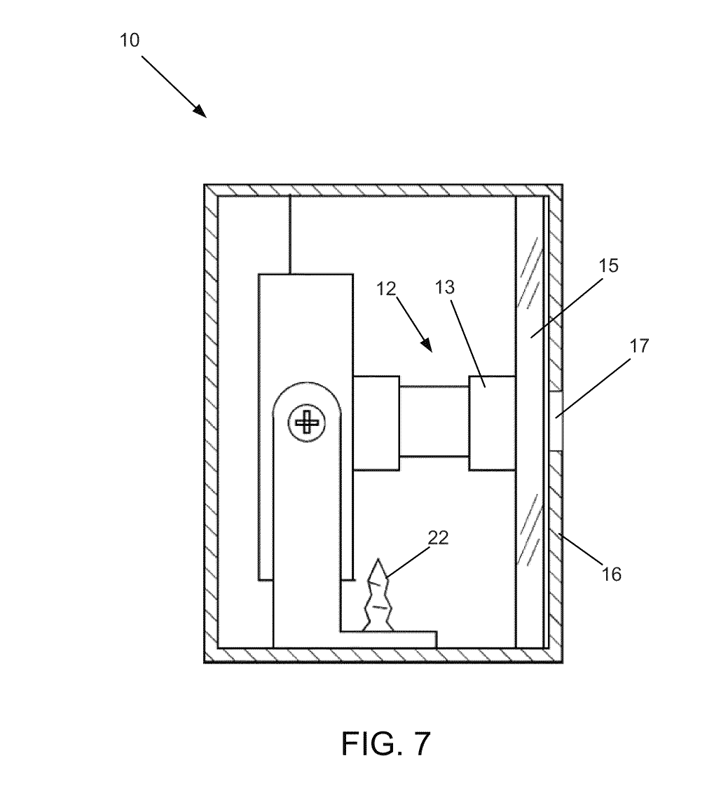

FIG. 6 illustrates a cross-sectional view of the top side of a portion of the surveillance device 10 that contains the first camera 12 and second camera 14. The first and second cameras 12, 14 may be positioned adjacent to one another and face opposite directions as shown in FIG. 6. By placing the cameras 12, 14 next to one another the thickness t of the housing 11 of the surveillance device 10 may be decreased. The first camera opening 17 allows the first video camera 12 to capture images/activity (e.g., record first video data) occurring outside of the housing 11 of the surveillance device 10. The second camera opening 23 allows the second video camera 14 to capture additional images/activity (e.g., record second video data) occurring outside of the housing 11 of the surveillance device 10.

In one embodiment, a protective covering 15, such as plexi-glass, bullet-resistant glass, plastic, or glass, lies between the lens 13 of the first camera 12 and the first camera opening 17 on the front surface 16 of the surveillance device 10. The protective covering 15 protects the lens 13 from intentional and unintentional harm, and the natural elements. Similarly, another protective covering 21 may lie in between the lens 19 of the second camera 14 and the second camera opening 23 on the rear surface 18 of the surveillance device 10 to protect the lens 19 of the second camera 14. The protective coverings 15, 21 may be, for example, ⅛^{th} of inch thick plexi-glass material that is affixed to the inner wall of the surveillance device 10 with an adhesive. In other embodiments, the protective coverings 15, 21 may be absent in which case the lenses 13, 19 may sit flush against the first and second camera openings 17, 23. In some embodiments, desiccants may be placed within the surveillance device 10 to help control any moisture that may accumulate within the surveillance device 10. In yet other embodiments, the cameras 12, 14 may be water-resistant and/or may be substantially covered in a protective sheathing, such as plastic, to protect from water damage.

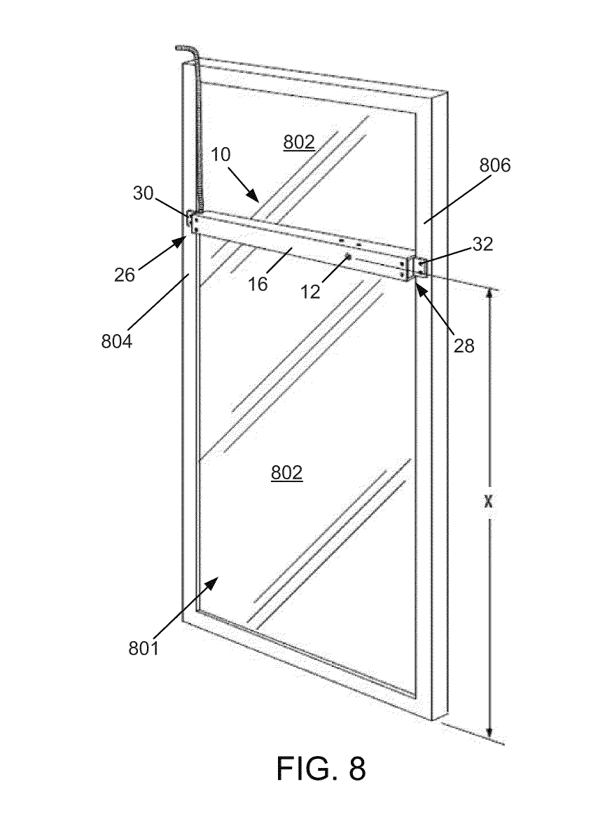

FIG. 7 illustrates a cross-sectional view of an end of the surveillance device 10 that shows the first camera 12 being held in place by the first camera fastener 22. The surveillance device 10 may feature the first camera opening 17 through which the first camera 12 captures video images. The protective covering 15 may help protect the lens 13 of the first camera 12.

Operation of Surveillance Device

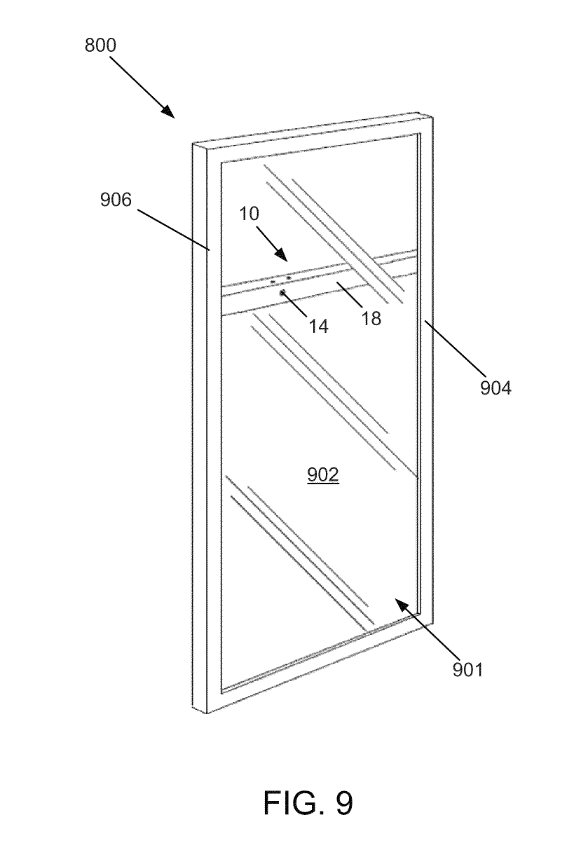

FIGS. 8 and 9 illustrate a door 800 featuring a surveillance device 10 that captures images of an interior area (e.g. first area) and an exterior area (e.g., second area) of a doorway associated with the door 800. In the embodiments illustrated in FIGS. 8 and 9, the door 800 may be a “swing door” that can be opened and closed in two directions and provides access through the doorway. FIG. 8 illustrates the interior side 801 (e.g., first side) of the door 800 that faces in toward the interior of the room (e.g., toward the first area) and the interior area of the doorway when the door 800 is closed. FIG. 9 illustrates the exterior side 901 (e.g., second side) of the door 800 that faces out toward the exterior of the room (e.g., toward the second area) and exterior area of the doorway when the door is closed. The door 800 comprises a door body having an interior face 802 and an exterior face 902, a first interior perimeter portion 804, a second interior perimeter portion 806, a first exterior perimeter portion 904, and a second exterior perimeter portion 906. In one embodiment, the interior and exterior faces 802, 902 of the door's 800 body may be substantially transparent thereby allowing the exterior area of doorway to be visible from inside the room and the interior area of the doorway to be visible from outside the room.

Referring to FIG. 8, a surveillance device 10 is mounted onto the interior side 801 of the door 800, preferably at a height “X” that is about face level with the height of an average adult person. The surveillance device 10 is mounted to the first side 801 of the door 800 such that the first camera 12 is facing away from the first side 801 of the door 800, and the second camera 14 is facing toward the first side 801 of the door 800. In one embodiment, the first end 26 of the surveillance device 10 may be affixed onto or near the first interior perimeter portion 804 of the door 50 via the first end bracket 30. The first interior perimeter portion 804 of the door 800 may be near the edge of the door 800 that attaches to the doorway via hinges. The second end 28 of the surveillance device 10 may be affixed onto or near the second interior perimeter portion 806 of the door via the second end bracket 32. The second interior perimeter portion 806 of the door 800 may be near the edge of the door 800 that swings open. In one embodiment a cable 34 couples to the surveillance device 10 and serves to power and provide communications between the surveillance device 10 and an external storage device. In other embodiments the cable 34 is absent. In that case the surveillance device 10 may be powered by a replaceable and/or rechargeable battery, and the surveillance device 10 transmits the video images/data it captures to an external storage device via wireless communications. In other embodiments, the surveillance device 10 has an internal video storage device that stores video images captured onto memory stored within the surveillance device 10. The memory may be located on a removable device such as a thumb-drive having FLASH memory.

In one embodiment, the first camera 12 is configured to capture video images on the interior side 801 of the door 800. That is, the first camera 12 is configured to capture video images of an interior area/region in front of and at a distance from the interior side 801 of the door 800. Therefore, the first camera 12 is positioned to capture facial images of people approaching the door 800 from inside the room who, for example, wish to exit the room. The first camera may also be positioned to generally record video of activity within the room, for example, actions that are taking place at a cash register area within the room.

FIG. 9 illustrates the exterior side (e.g., the second side) 901 of the door 800. In one embodiment, the second camera 14 is configured to capture video images on the exterior side 901 of the door 800. That is, the second camera 14 is configured to capture video images of an exterior area/region in front of and at a distance from the exterior side 901 of the door 800. Since the surveillance device 10 is mounted onto the interior side 801 of the door, the surveillance device 10 cannot be directly tampered with by anyone outside the room/doorway because the device 10 is located inside the room. However, since the interior and exterior faces 802, 902 of the door's 800 body are substantially transparent, the second camera 14 of the surveillance device 10 is able to record activity taking place on the exterior side 901 of the door 800. Therefore, the second camera 14 is positioned to capture facial images of people approaching the door 800 from outside the room who, for example, wish to enter the room.

For example, as a person located inside the room approaches the first side 801 of the door 800, the first camera 12 may capture a full frontal shot of the person's face. As the person pushes or pulls the door 800 open, one or both of the first and second cameras 12, 14 begin to capture various angles of the person's face, including profile images. Moreover, once the person has completely walked through the doorway and is traversing though the exterior area of the doorway, the second camera 14 is now in a position to capture images of the back of the person's head and body as the person walks away from the exterior side 901 of the door 800. Capturing close-up facial images of people entering and exiting through the door 800 may help assist law enforcement personnel in tracking down suspected criminals, missing persons, and other people of interest.

Furthermore, the cameras 12, 14 are capable of capturing more than just the facial images of people entering and exiting through the door 800. While the cameras 12, 14 are unobstructed by a person entering or exiting through the door 800, the cameras 12, 14 are capable of capturing images of all activity within their viewing angles, even at some considerable distance. For example, the surveillance device 10 may be implemented onto the front door of a convenience store. One camera 12 that faces in toward the store may be positioned to capture video images of activity taking place inside the convenience store. For example, the camera 12 may record images of people exiting the store. The camera 12 may also monitor and record activity taking place at a cash register area of the convenience store that is some distance, for example 25 feet or more, away from the door 800. The second camera 14 facing the other side of the entrance door 800 may simultaneously record activity taking place outside the convenience store. For example, the camera 14 may record images of people entering the store. The camera 14 may also monitor and record activity taking place in the parking lot and exterior portion of the convenience store. In this fashion, the cameras 12, 14 act to record not only the facial images of patrons walking into and out of the store, but also work to capture surveillance images of activity taking place (e.g., activity near the cashier and/or parking lot) at a significant distance from the door 800 to which the cameras 12, 14 are attached.

In the embodiments shown in FIGS. 8 and 9, the surveillance device 10 is mounted onto the interior side 801 of the door 800. However, in other embodiments, the surveillance device 10 may be mounted onto the exterior side 901 of the door 800. In that case, the first end 26 of the surveillance device 10 may be affixed onto or near the first exterior perimeter portion 904 of the door 800 via the first end bracket 30, and the second end 28 of the surveillance device 10 may be affixed onto or near the second exterior perimeter portion 906 of the door 800 via the second end bracket 32.

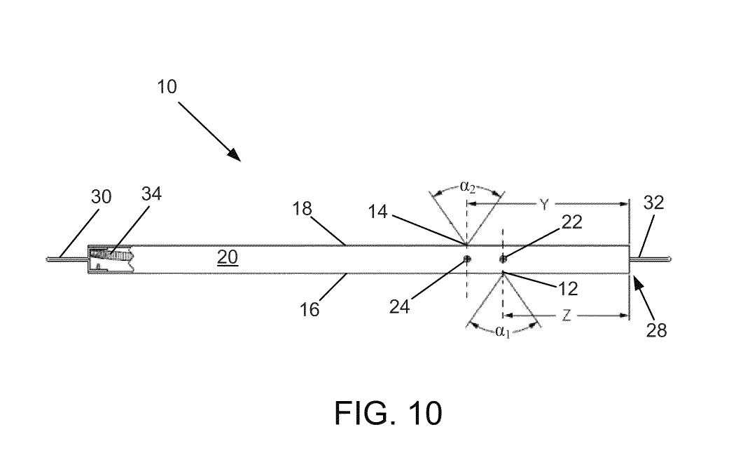

FIG. 10 illustrates a top-side view of the surveillance device 10. The angles α₁ and α₂ respectively represent the horizontal (i.e., in a direction parallel to the length l of the surveillance device 10) viewing angles that can be recorded by the first and second cameras 12, 14 when the surveillance device 10 is in a stationary position (e.g., in a closed position). The first camera 12 may be located a distance Z from the second end 28 of the surveillance device 10. The second camera 14 may be located a distance Y from the second end 28 of the surveillance device 10. In the embodiments shown in at least FIGS. 2, 3, 6, 7, 8, 9, and 10, the first and second cameras 12, 14 are located at slightly different distances from the second end 28 of the surveillance device 10 so that the surveillance device 10 can have a thin profile. In other words, the first and second cameras may be located adjacent to one another along the length/of the housing 11 of the security device 10. In other embodiments, the cameras 12, 14 may be equally spaced from the second end 28, in which case the surveillance device 10 may be thicker (have a larger thickness t) so as to accommodate the camera bodies of each of the first and second cameras 12, 14 within the housing 11 of the surveillance device 10.

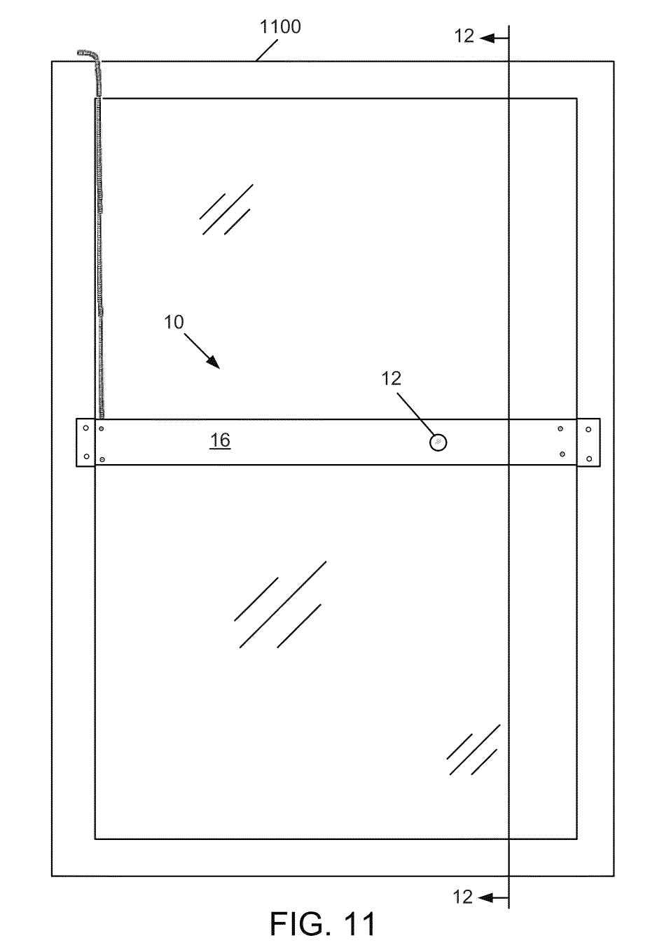

FIG. 11 illustrates a surveillance device 10 attached to a substantially transparent door 1100.

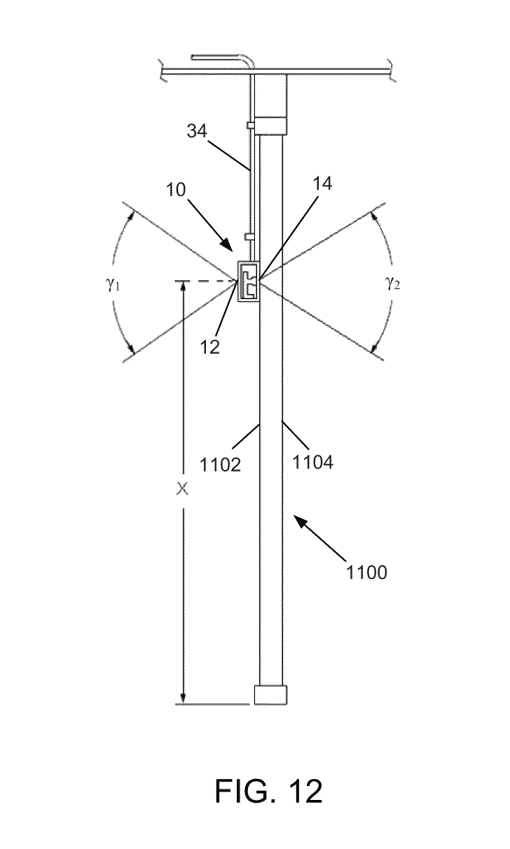

FIG. 12 illustrates a cross-sectional view of the door 1100 and the surveillance device 10 attached thereto shown in FIG. 11. The door 1100 may have an interior side (e.g., first side) 1102 and an exterior side (e.g., second side) 1104, where a first area/region within an interior of a room is associated with the interior side 1102 and a second area/region within an exterior of a room is associated with the exterior side 1104 of the door 1100. The angles γ₁ and γ₂ respectively represent the vertical (i.e., in a direction parallel to the height h of the surveillance device 10) viewing angles that can be recorded by the first and second cameras 12, 14 when the surveillance device 10 is attached to the door 1100 at a height X from the ground. The height X may be the average height of a human in the locale (e.g., city, state, country, etc.) of the door 1100, e.g., a height between four feet six inches and six feet six inches.

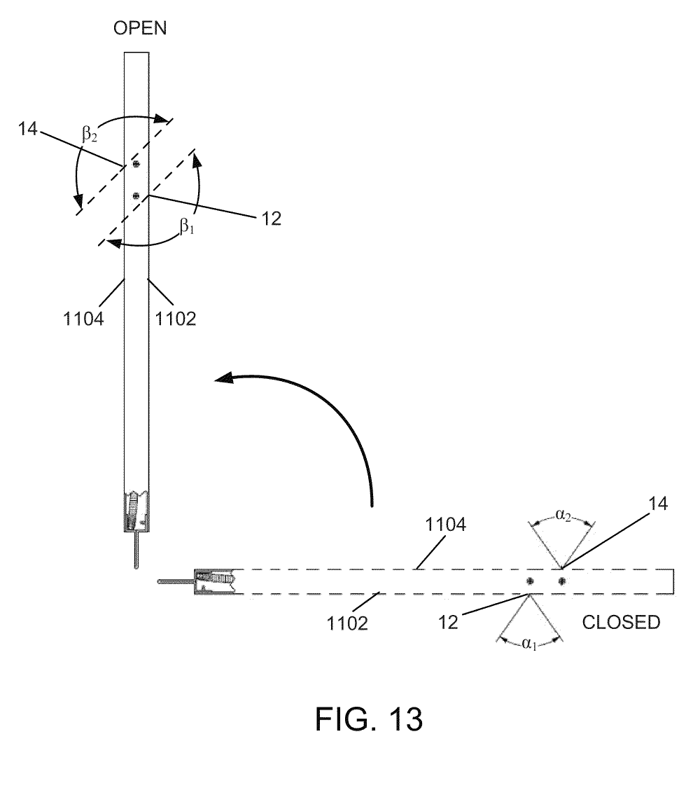

FIG. 13 illustrates a top side view of the surveillance device 10 of the door 1100 being moved (e.g., pushed or pulled by a person) from an initial CLOSED position (dashed lines) to an OPEN position (solid lines). The door 1100, to which the surveillance device 10 is attached, has been removed from the figure for clarity. FIG. 13 illustrates the wider panoramic viewing angles afforded by the surveillance device 10 as the door 1100 and the attached surveillance device 10 is swung between the CLOSED and OPEN position. In the static, CLOSED position, the first camera 12 records images within a viewing angle of α₁ and the second camera 14 records images within a viewing angle of α₂. As the door 50 swings to the OPEN position, the first camera 12 is able to capture images having a total viewing angle of β₁ which may be substantially greater than α₁ alone. In some cases, the images recorded by the first camera within the viewing angle β₁ may include images that are found on both sides of the doorway (i.e., images found in the first area and second area of the doorway).

Simultaneously, the second camera 14 is able to capture images within a total viewing angle of β₂ which may be substantially greater than α₂ alone. In some cases, the images recorded by the second camera within the viewing angle β₂ may include images that are found on both sides of the doorway (i.e., images found in the first area and second area of the doorway). This allows a viewing angle of more than 180 degrees to be recorded between the two cameras 12, 14 if, for example, the door is swung open on one direction, for example, toward the exterior or interior area of the doorway. If the door is a “swing door,” then an even greater viewing angle may recorded by swinging the door open in both directions. In one embodiment, the first and second cameras may record a combined horizontal viewing angle of more than 300 degrees when the surveillance device 10 is used with a swing door. For example, in the event the swing door is swung open toward the exterior area of the doorway and then pulled back through the doorway into an interior area of the doorway.

In some cases, the first and second cameras 12, 14 may be able to record activity within a wide viewing angle even if the door is not a swing door. For example, the first and second cameras 12, 14 may each have a viewing angle in the horizontal direction of 160 degrees because they utilize, for example, a “fish eye” lens. In such embodiments, the two cameras 12, 14 together may record images on both sides of the door within a viewing angle of more than 300 degrees.

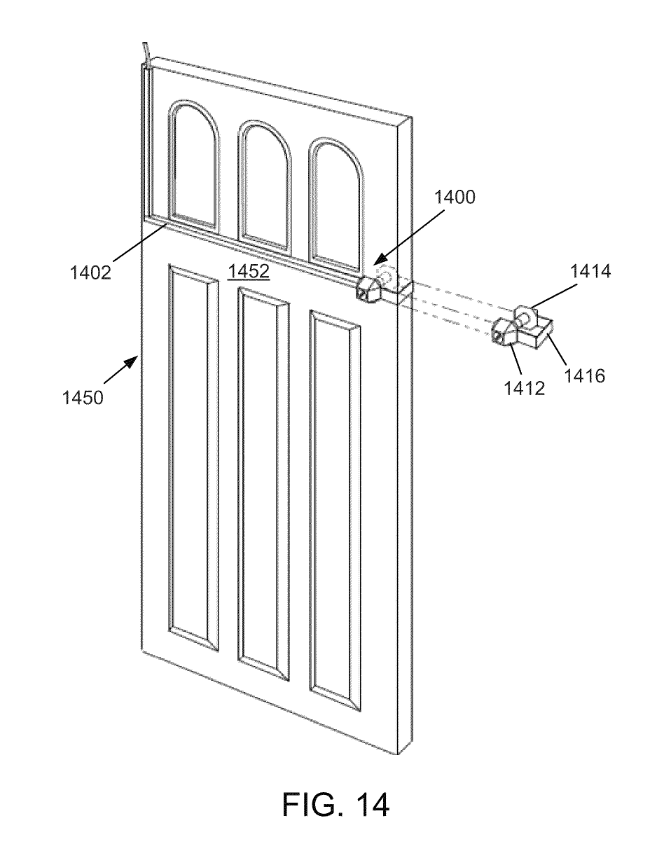

FIG. 14 illustrates another embodiment of a surveillance device 1400 that may be mounted on an opaque door 1450 to provide video surveillance of both the interior and exterior areas of the door 1450. For example, a first camera 1412 may be mounted on the interior side 1452 of the door 1450 and positioned at a height X to capture video images of the interior area of the door 1450. The first camera 1412 may be contained, at least partially, within a first cavity defined by a first casing (e.g., first housing). The height X may be the average height of a human in the locale (e.g., city, state, country, etc.) of the door 1450. The door 1450 may be a standard wooden door used as a front door to a house. Thus, the first camera 1412 is positioned to capture images, such as full frontal shots of a person's face, inside the house near the interior area of the door 1450.

A second camera 1414 may be mounted on the exterior side of the door 1450 to capture video images of the exterior area of the door 1450 (e.g., outside the house). The second camera 1414 may be contained, at least partially, within a second cavity defined by a second casing (e.g., second housing). The second camera 1414 may also be positioned at a height X to capture full frontal facial video images of persons standing outside the door 1450. The second camera may be connected to the first camera 1412 via a connecting communications line 1416. The connecting communications line 1416 transmits images captured by the second camera 1414 to the surveillance device 1400. The connecting communications line 1416 may also power the second camera 1414. The connecting communications line 1416 may be comprised of a thin, flat insulating fabric containing conducting wires, such as surface mountable wiring. The connecting communications line 1416 may be flat and thin so that the door 1450 may close within the doorjab without significant obstruction by the connecting communications line 1416.

In one embodiment a main communications line 1402 couples to the surveillance device 1400 and serves to power and provide communications between the surveillance device 1400 and an external storage device. In other embodiments the cable 1402 is absent. In that case the surveillance device 1400 may be powered by a replaceable and/or rechargeable battery, and the surveillance device 1400 transmits the video images/data it captures to an external storage device via wireless communications. In other embodiments, the surveillance device 1400 has an internal video storage device that stores video images captured onto memory stored within the surveillance device 1400. The memory may be located on a removable device such as a thumb-drive having FLASH memory.

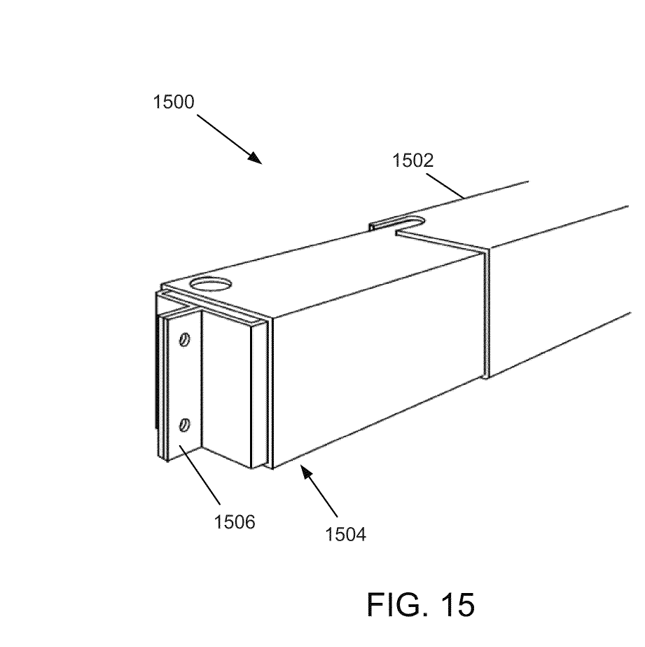

FIG. 15 illustrates one embodiment of a surveillance device 1500 featuring a housing 1502 with a telescoping end 1504. The telescoping end 1504 allows the length l of the surveillance devices 10, 1500 to be lengthened or shortened in order to accommodate the width of a door 50 to which the surveillance devices 10, 1500 may attach to via the end bracket 1506. For example, the second end 28 of the surveillance device 10 shown in FIG. 8 may be a telescoping end 1504 that can extend out toward and attach to the second interior perimeter portion 806 of the door 800 via the second bracket 32. In this fashion, the telescoping end 1504 allows the surveillance devices 10, 1500 to accommodate a door 800 of various widths.

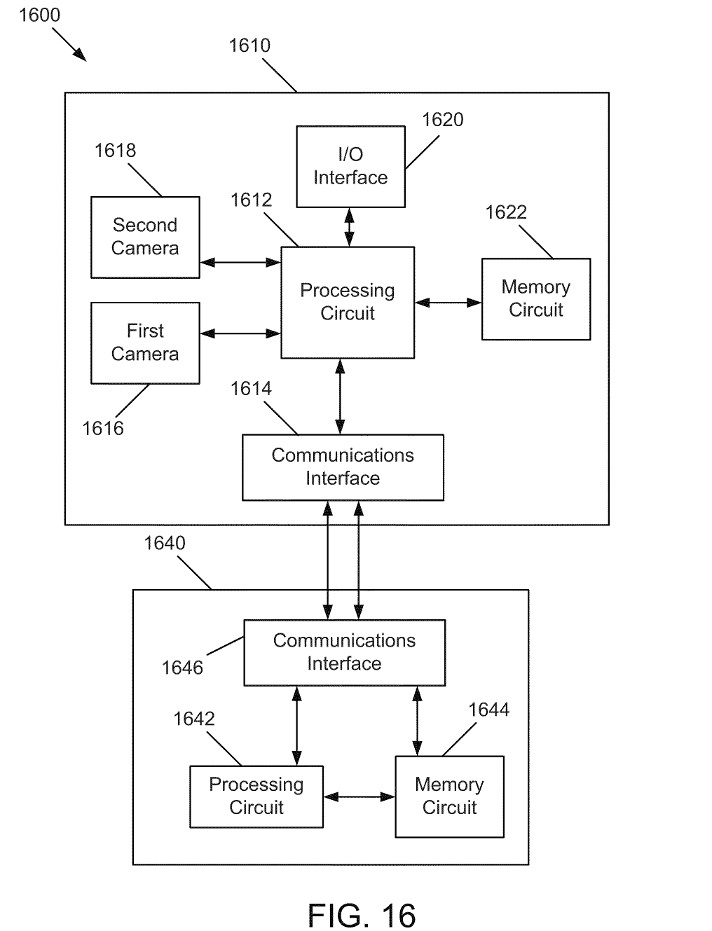

FIG. 16 illustrates a functional block diagram of a surveillance system 1600 comprising a surveillance device 1610 and an external storage device 1640 according to one embodiment. The surveillance device 1610 may comprise a processing circuit 1612 (e.g., processor, computer, microprocessor, graphics processor, etc.), a communications interface 1614, a first video camera (e.g., first camera) 1616, a second video camera (e.g., second camera) 1618, an input/output (I/O) interface 1620, and a memory circuit (memory, etc.) 1622. The processing circuit 1612 may be communicatively coupled to the communications interface 1614, the first video camera 1616, the second video camera 1618, the input/output (I/O) interface 1620, and/or the memory circuit 1622. Generally, the processing circuit 1612 is responsible for processing data, such as, transmitting and receiving instructions to the various components of the surveillance device 1610. For example, the processing circuit 1612 may transmit instructions to the first and second cameras 1616, 1618 to start and stop acquiring video data. The processing circuit 1612 may also receive video data acquired by the first and/or second cameras 1616, 1618 and transmit such data to the communications interface 1614. The I/O interface 1620 may comprise an ON/OFF switch (e.g., an infrared input that receives ON/OFF signals) that is responsible for powering on the surveillance device 1610 and sending commands to the processing circuit 1612 to begin video recording operations. The memory circuit 1622 is responsible for storing data and can assist the processing circuit 1612 by storing data, such as instructions, in volatile (DRAM, SRAM, etc.) and/or non-volatile memory (e.g., FLASH memory).

The communications interface 1614 may be responsible for transmitting video data acquired from the first and/or second cameras 1616, 1618 to the external storage device 1640. The communications interface 1614 may also be responsible for receiving power to operate the surveillance device 1610. In one embodiment the communications interface 1614 provides a wireline connection from the surveillance device 1610 to the external storage device 1640. In another embodiment, the communications interface 1614 provides a wireless communications interface/connection to the external storage device 1640. In this fashion, the surveillance device 1610 can wireless transmit video data to the external storage device 1640.

The external storage device 1640 comprises a processing circuit 1642, one or more memory circuits 1644, and a communications interface 1646. The external storage device 1640 receives video data acquired by the surveillance device 1610 and stores the video data in its memory circuits 1644. For example, the surveillance device 1610 may receive the video data via its communications interface 1646. The communications interface 1646 and transmit the data to its processing circuit 1642 which in turn instructs the memory circuits 1644 to store the video data. The memory circuits may be for example a hard disk drive, a solid state drive, volatile memory, and/or non-volatile memory such as FLASH memory.

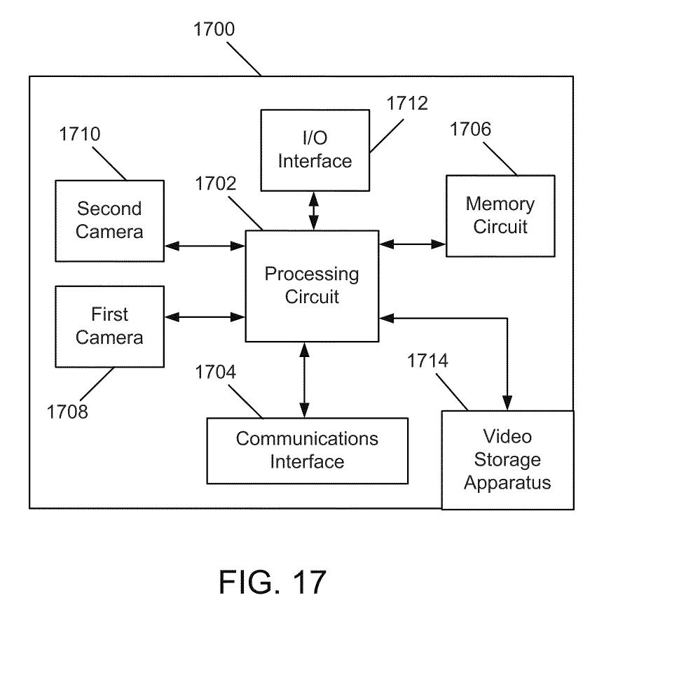

FIG. 17 illustrates a functional block diagram of a surveillance device 1700 according to another embodiment. The surveillance device 1700 may comprise a processing circuit 1702 (e.g., processor, computer, microprocessor, graphics processor, etc.), a communications interface 1704, a memory circuit (e.g., memory, etc.) 1706, a first video camera (e.g., first camera) 1708, a second video camera (e.g., second camera) 1710, an input/output (I/O) interface 1712, and a video data storage apparatus 1714.

The processing circuit 1702 may be communicatively coupled to the communications interface 1704, the memory circuit 1706, the first video camera 1708, the second video camera 1710, the I/O interface 1712, and/or the video data storage apparatus 1714. Generally, the processing circuit 1702 is responsible for processing data, such as, transmitting and receiving instructions to the various components of the surveillance device 1700. For example, the processing circuit 1702 may transmit instructions to the first and second cameras 1708, 1710 to start and stop acquiring video data. The processing circuit 1702 may also receive video data acquired by the first and/or second cameras 1708, 1710 and transmit such data to the video data storage apparatus 1714 for storage. The I/O interface 1712 may comprise an ON/OFF switch (e.g., an infrared input that receives ON/OFF signals) that is responsible for powering on the surveillance device 1700 and sending commands to the processing circuit 1702 to begin video recording operations. The memory circuit 1706 is responsible for storing data and can assist the processing circuit 1702 by storing data, such as instructions, in volatile (DRAM, SRAM, etc.) and/or non-volatile memory (e.g., FLASH memory).

The video data storage apparatus 1714 comprises one or more storage elements configured to store video data. For example, the video data storage apparatus 1714 may comprise a hard disk drive, a solid state drive, volatile memory, and/or non-volatile memory such as FLASH memory. In one embodiment, the video data storage apparatus 1714 includes banks of FLASH memory configured to store large amounts of video data. The video data storage apparatus 1714 may be removably coupled to the rest of the surveillance device 1700, for example, through a USB, 1394, Thunderbolt®, or any other communications connection protocol. If the video data storage apparatus 1714 is removably coupled to the surveillance device 1700, then a user can conveniently remove the video data storage apparatus 1714 containing relevant video data and copy it to another device such as a computer for analysis or video reproduction.

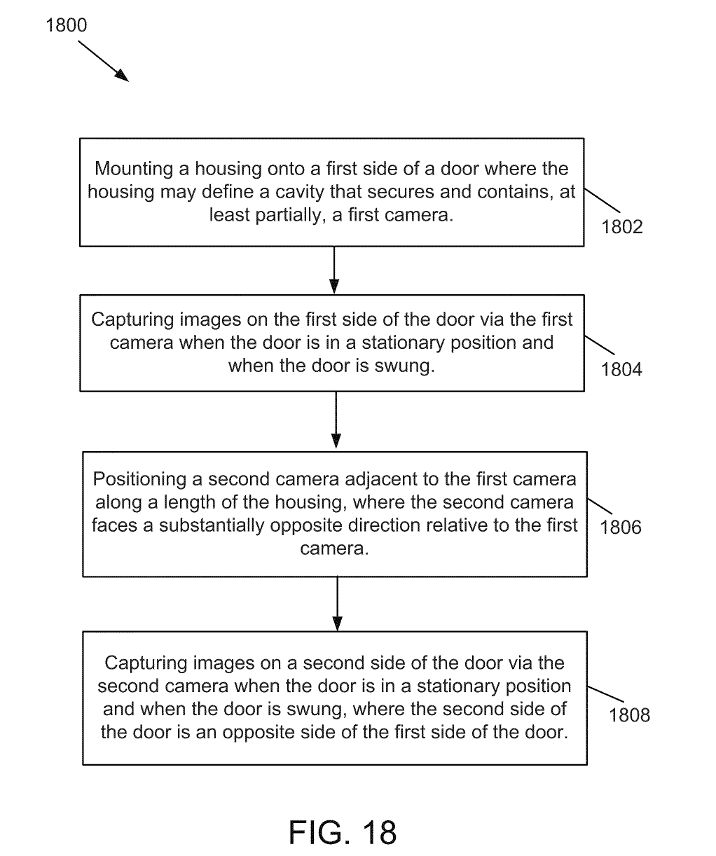

FIG. 18 illustrates a flowchart of an exemplary method 1800 for capturing surveillance images of objects (e.g., facial images of people) on a first side and/or second side of a doorway. For example, the method may include mounting a housing onto a first side of a door where the housing may define a cavity that secures and contains, at least partially, a first camera 1802. The method may further include capturing images on the first side of the door via the first camera when the door is in a stationary position and when the door is swung 1804. Next, the method may include positioning a second camera adjacent to the first camera along a length of the housing, where the second camera faces a substantially opposite direction relative to the first camera 1806. The cavity of the housing may further secure and contain the second camera. Furthermore, the method may include capturing images on a second side of the door via the second camera when the door is in a stationary position and when the door is swung, where the second side of the door is an opposite side of the first side of the door 1808.

In one embodiment, the step 1802 of mounting the housing onto the first side of the door may comprise mounting a first end of the housing to a first perimeter portion of the door via a first bracket, and mounting a second end of the housing to a second perimeter portion of the door via a second bracket. The second end of the housing may be defined as an opposite end of the first end. Also, mounting the first end to the first perimeter portion of the door and mounting the second end to the second perimeter portion of the door may align the housing in a substantially horizontal direction across the door (e.g., see the surveillance device 10 in FIG. 1).

In yet other embodiments, the first and second cameras may be linked to a facial image recognition system to allow select personnel access to a restricted area. In yet other embodiments, the surveillance device may feature more than two cameras. Moreover, embodiments of the surveillance device are not limited to just video cameras. Rather, the surveillance device may feature infrared cameras that detect heat, and/or other recording devices that capture light outside of the visible spectrum (approximately 390 nm to 750 nm). In other embodiments, cameras may be implemented within the surveillance device that capture still images. In alternative embodiments, the first and second video cameras within any of the surveillance devices disclosed herein may feature a “fisheye” lens so that a wider viewing angle is captured/recorded. Thus, the angles α and β illustrated in FIGS. 10, 12, and 13 may be even larger. In yet other embodiments, the surveillance device 10 may be equipped with one or more motion sensors found on any one of the surfaces of the housing 11. The motion sensors may trigger the first camera 12 and/or second camera 14 to capture an image if, for example, an object enters within range of the motion sensor and/or the door is swung in any direction.

A surveillance device may be customized to feature any one of the aforementioned style of cameras, and/or number of cameras on the surveillance device. For example, a website may allow a user to customize an order for a surveillance device that features infrared and regular video cameras on each side of the device. The website may further allow the user to customize the length, width, depth, and other physical attributes of the surveillance device. Another feature that may be customized for a given order is the layout of the surveillance device depending on whether the door on which the surveillance device is to be installed on has hinges on the left side or the right side, and/or whether the door is a standard hinged door or whether it's a “swing door.”

The surveillance devices disclosed herein provide at least the following features. First, a panoramic viewing angle of the exterior and/or interior of a doorway may be recorded, instead of a limited viewing angle that focuses just outside or inside of a doorway. This may allow, for example, the parking lot or other area external to and some distance away from the doorway to be recorded. Second, since the surveillance devices may be mounted at a height approximately equal to the face of a person, accurate facial images may be acquired. Such detailed images may help law enforcement apprehend a suspect or locate a person of interest. Third, the surveillance devices can be manufactured so that they are compact, lightweight and easy to install. Conventional security cameras mounted to walls may require costly installation procedures and damage to such structures. Fourth, by placing the cameras within the surveillance device, the cameras are relatively inconspicuously hidden so as not to be offensive to ordinary individuals/customers entering or leaving through a doorway.

One or more of the components, steps, features and/or functions illustrated in FIGS. 1, 2, 3, 4, 5, 6, 7, 8, 9, 10, 11, 12, 13, 14, 15, 16, 17, and/or 18 may be rearranged and/or combined into a single component, step, feature or function or embodied in several components, steps, or functions. Additional elements, components, steps, and/or functions may also be added without departing from the invention. The apparatus, devices, and/or components illustrated in FIGS. 1, 2, 3, 4, 5, 6, 7, 14, 15, 16, 17, and/or 18 may be configured to perform one or more of the methods, features, or steps described in FIGS. 8, 9, 10, 11, 12, 13 and/or 18. The algorithms described herein may also be efficiently implemented in software and/or embedded in hardware.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums and, processor-readable mediums, and/or computer-readable mediums for storing information. The terms “machine-readable medium”, “computer-readable medium”, and/or “processor-readable medium” may include non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines and/or devices.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications are possible. Those skilled, in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

What is claimed is:

1. A surveillance device, comprising:
a first camera; and
a housing defining a cavity that secures and contains, at least partially, the first camera, the housing having a first camera opening and adapted to mount onto a first side of a door, wherein the first camera is adapted to capture images through the first camera opening when the door is swung.

2. The surveillance device of claim 1, wherein the first camera is further adapted to capture images intermittently at a preset interval of time.

3. The surveillance device of claim 1, further comprising a motion sensor, wherein the first camera is further adapted to capture images after the motion sensor is triggered by movement of an object within range of the motion sensor.

4. The surveillance device of claim 1, wherein the housing is adapted to mount to the first side of the door in a horizontal orientation.

5. The surveillance device of claim 1, wherein the housing has a length that extends to a first edge of the door, the length of the housing adapted to protect a power line and a communications line contained within the cavity of the housing, the power line adapted to provide power to the first camera, and the communications line adapted to transmit images captured by the first camera to an external storage device.

6. The surveillance device of claim 1, wherein the first camera is further adapted to capture images when the door is in a stationary position.

7. The surveillance device of claim 1, wherein the housing comprises:
a first end and a second end, the second end located opposite to the first end, and wherein at least one of the first end and the second end is a telescoping end.

8. The surveillance device of claim 1, wherein the housing comprises:
a first end and a second end, the second end located opposite to the first end, the first end having a first end bracket adapted to couple the first end of the housing to a first perimeter portion of the door, and the second end having a second end bracket adapted to couple the second end of the housing to a second perimeter portion of the door.

9. The surveillance device of claim 1, further comprising:
a video data storage apparatus adapted to store images captured by the first camera on at least one memory circuit housed within the storage apparatus, wherein the video data storage apparatus is removably coupled to the surveillance device.

10. The surveillance device of claim 1, wherein the first camera is positioned at a height between four (4) feet six (6) inches and six (6) feet six (6) inches to capture facial images of humans.

11. The surveillance device of claim 1, further comprising:
a second camera contained, at least partially, within the cavity of the housing and adapted to capture additional images through a second camera opening in the housing when the door is swung, the second camera positioned within the cavity in a direction substantially opposite the first camera such that the images captured by the first camera are on the first side of the door, and the additional images captured by the second camera are on a second side of the door, the second side of the door being an opposite side of the first side of the door.

12. The surveillance device of claim 11, wherein the first camera is positioned adjacent to the second camera along the length of the housing to reduce the thickness of the housing.

13. The surveillance device of claim 11, wherein the surveillance device is adapted to mount to a substantially transparent door.

14. The surveillance device of claim 1, wherein the first camera is adapted to capture the images within a viewing angle α₁ on the first side of the door when the door is in a stationary position, and the first camera is adapted to capture the images located within a viewing angle β₁ when the door is in motion, wherein β₁ is greater than α₁.

15. The surveillance device of claim 14, wherein the viewing angle β₁ includes images located on both sides of a doorway securing the door.

16. The surveillance device of claim 15, further comprising:
a second camera contained, at least partially, within the cavity of the housing and adapted to capture additional images through a second camera opening in the housing when the door is swung, the second camera positioned within the cavity in a direction substantially opposite the first camera, the second camera adapted to capture the additional images located within a viewing angle β₂ when the door is in motion, wherein β₁+β₂ is greater than 180 degrees.

17. A method for capturing surveillance images, the method comprising:
mounting a housing onto a first side of a door, the housing defining a cavity that secures and contains, at least partially, a first camera; and
capturing images on the first side of the door via the first camera when the door is in a stationary position and when the door is swung.

18. The method of claim 17, further comprising:
positioning a second camera adjacent to the first camera along a length of the housing, the second camera facing a substantially opposite direction relative to the first camera, wherein the cavity of the housing further secures and contains the second camera; and
capturing images on a second side of the door via the second camera when the door is in a stationary position and when the door is swung, the second side of the door being an opposite side of the first side of the door.

19. The method of claim 17, wherein mounting the housing onto the first side of the door comprises:
mounting a first end of the housing to a first perimeter portion of the door via a first bracket; and
mounting a second end of the housing to a second perimeter portion of the door via a second bracket, the second end of the housing opposite the first end, wherein mounting the first end to the first perimeter portion of the door and mounting the second end to the second perimeter portion of the door aligns the housing in a substantially horizontal direction across the door.

20. A surveillance device, comprising:
a first camera adapted to capture images on a first side of a door;
a second camera adapted to capture additional images on an opposite side of the door;
a first housing defining a first cavity that contains, at least partially, the first camera, the first housing adapted to mount to the first side of the door at a first height between four (4) feet six (6) inches and six (6) feet six (6) inches from a bottom edge of the door;
a second housing defining a second cavity that contains, at least partially, the second camera, the second housing adapted to mount to the second side of the door at a second height between four (4) feet six (6) inches and six (6) feet six (6) inches from the bottom edge of the door; and
a connecting communications line communicatively coupling the second housing to the first housing, wherein the first camera is adapted to transmit the images captured to an external storage device, and the second camera is adapted to transmit the additional images captured to the external storage device via, at least, the connecting communications line.
